(19) United States
(12) Patent Application Publication
(10) Pub. No.: US 2019/0146771 A1
(43) Pub. Date: May 16, 2019

(54) SELF-UPDATING METHOD AND APPARATUS FOR REMOTE ASSISTANCE

(71) Applicants: QINGDAO HISENSE ELECTRONICS CO., LTD., Qingdao (CN); Jamdeo Canada Ltd., Oakville (CA)

(72) Inventors: Terry VOTH, Oakville, CA (US); Mikhail SHOYKHER, Oakville, CA (US); Tong CHEN, Oakville, CA (US)

(21) Appl. No.: 15/750,059

(22) PCT Filed: Nov. 20, 2017
(86) PCT No.: PCT/CN2017/111941

§ 371 Date: Feb. 2, 2018

(30) Foreign Application Priority Data
Nov. 16, 2017 (CN) 201711140628.1

(51) Int. Cl. G06F 8/65; G06F 9/445

(52) U.S. Cl. CPC G06F 8/65; G06F 9/44526

(57) ABSTRACT

The present disclosure provides a self-updating method and apparatus for remote assistance. After receiving a startup instruction, a core component of a client automatically sends information associated with a device to a server, and by using the information associated with the device, the server searches for a stored updated extension library that matches the information, wherein the updated extension library is the latest extension library provided by an administer of a manufacturer of a device. After the server sends the searched updated extension library to the core component of the client, the core component saves the updated extension library in an extension library component and dynamically loads the updated extension library, so as to automatically update the client.

This application is a National Stage of International Application No. PCT/CN2017/111941, filed Nov. 20, 2017, which claims priority to Chinese Patent Application No. 201711140628.1, filed Nov. 16, 2017, both of which are hereby incorporated by reference in their entireties.

### FIELD

This disclosure relates to the field of communications, and particularly to a self-updating method and apparatus for remote assistance.

### BACKGROUND

At present, with the development of internet technology, the remote assistance technology will be used in more and more fields. The remote assistance is a technology where one computer device remotely controls another computer device via the network.

### SUMMARY

Embodiments of the present disclosure provide a self-updating method and apparatus for remote assistance.

An embodiment of the present disclosure provides a self-updating method for remote assistance, including: receiving, by a server, information associated with a device sent from a core component of a client which is running on the device; searching, by the server, for an updated extension library stored in the server which matches the information associated with the device; and sending, by the server, the searched updated extension library to the core component of the client such that the core component saves the updated extension library in an extension library component of the client and dynamically loads the updated extension library.

An embodiment of the present disclosure provides another self-updating method for remote assistance, including: sending, by a core component of a client running on a device, information associated with the device to a server after receiving a startup instruction; receiving, by the core component of the client, an updated extension library which matches the information associated with the device, sent from the server; and saving, by the core component of the client, the updated extension library into an extension library component of the client and dynamically loading the updated extension library.

An embodiment of the present disclosure provides a server, including a memory and a processor, wherein the memory stores a computer program, and execution of the computer program by the processor causes the processor to: receive information associated with a device sent from a core component of a client which is running on the device; search for an updated extension library stored in the server which matches the information associated with the device; and send the searched updated extension library to the core component of the client such that the core component saves the updated extension library in an extension library component of the client and dynamically loads the updated extension library.

An embodiment of the present disclosure provides a terminal, including a processor and a memory, wherein the memory stores a computer program, and execution of the computer program by the processor causes the processor to: send information associated with the terminal to a server after receiving a startup instruction; receive an updated extension library which matches the information associated with the terminal, sent from the server; and save the updated extension library into an extension library component within the terminal and dynamically load the updated extension library.

An embodiment of the present disclosure provides a machine readable non-transitory storage medium, including program codes; the program codes are configured to enable computing equipment to execute operations of a self-updating method which is implemented at a client side according to the embodiment of the present disclosure, when the program codes run on the computing equipment.

An embodiment of the present disclosure provides a machine readable non-transitory storage medium, including program codes; the program codes are configured to enable computing equipment to execute operations of a self-updating method which is implemented at a server side according to the embodiment of the present disclosure, when the program codes run on the computing equipment.

### BRIEF DESCRIPTION OF THE DRAWINGS

FIG. 1 is a first schematic flow chart of a self-updating method for remote assistance which is implemented at a server side according to an embodiment of the present disclosure;

FIG. 2 is a second schematic flow chart of a self-updating method for remote assistance which is implemented at a server side according to an embodiment of the present disclosure;

FIG. 3 is a third schematic flow chart of a self-updating method for remote assistance which is implemented at a server side according to an embodiment of the present disclosure;

FIG. 4 is a schematic flow chart of a self-updating method for remote assistance which is implemented at a client side according to an embodiment of the present disclosure;

FIG. 5 is a schematic complete interaction diagram of a self-updating method for remote assistance according to an embodiment of the present disclosure;

FIG. 6 is a schematic structural diagram of a server according to an embodiment of the present disclosure;

FIG. 7 is a schematic structural diagram of a terminal according to an embodiment of the present disclosure;

FIG. 8 is another schematic structural diagram of a server according to an embodiment of the present disclosure;

FIG. 9 is a schematic structural diagram of a client according to an embodiment of the present disclosure.

### DETAILED DESCRIPTION OF THE EMBODIMENTS

In order to make the objects, the technical solutions and the advantages of this disclosure more apparent, the disclosure will be further described in details with reference to the drawings. Apparently the described embodiments are only a part but not all of the embodiments of this disclosure. Based upon the embodiments of this disclosure here, all of other embodiments derived by those ordinarily skilled in the art without any inventive effort shall come into the scope of this disclosure.

First, a brief description on client and application will be given.

A client can be regarded as an application, and refers to a program responsible to a server and used for providing local services to a user. Except for some applications that run locally only, clients are generally installed on ordinary client computers to work together with servers. After the development of the Internet, the more commonly used clients include web browsers for the World Wide Web, e-mail clients for sending and receiving e-mails, and client software for instant messaging, etc. For this kind of applications, appropriate servers and service programs are needed in a network to provide corresponding services, such as database services, e-mail services, etc.; therefore, it is needed to establish a specific communication connection at a client computer side and a server side to ensure a normal operation of an application.

With the development of computer networks, the form of connection changes gradually. So far, the two mainstream network connection modes are C/S and B/S modes, i.e., Client/Server and Browser/Server. Therefore, the client should be more understood under C/S mode. That is, by writing some programs to a client computer to ensure that even if a server has a failure or is under maintenance, the client can still work offline under the premise of ensuring work. While the applications may be working in the C/S mode or in the B/S mode.

A remote assistance solution typically consists of a client running on a device (e.g., a TV) owned by an end user and located remotely from the manufacturer of the device, and a server which acts as a contact point for the client to communicate with.

Whether it is a device failure caused by a software issue within the device itself or by a usage issue due to the user, the user can start the client for remote assistance.

When the client is started by the user, it communicates with the server. The application (e.g., a client or a browser) used by a Customer Service Representative (CRS) working for the manufacturer of the device is able to communicate with the server as well and, to communicate with the client indirectly through the server. In this way, the application used by the CRS is able to communicate with the client running on a remote device to download information from the device or upload information to the device.

Clients are installed on devices (e.g., TVs) before product delivery or before releasing to market. When discovering that the client on a device needs to be updated, the user usually need to interact with the manufacturer of the device, which makes the update of the client more complicated and impairs the experience of the user.

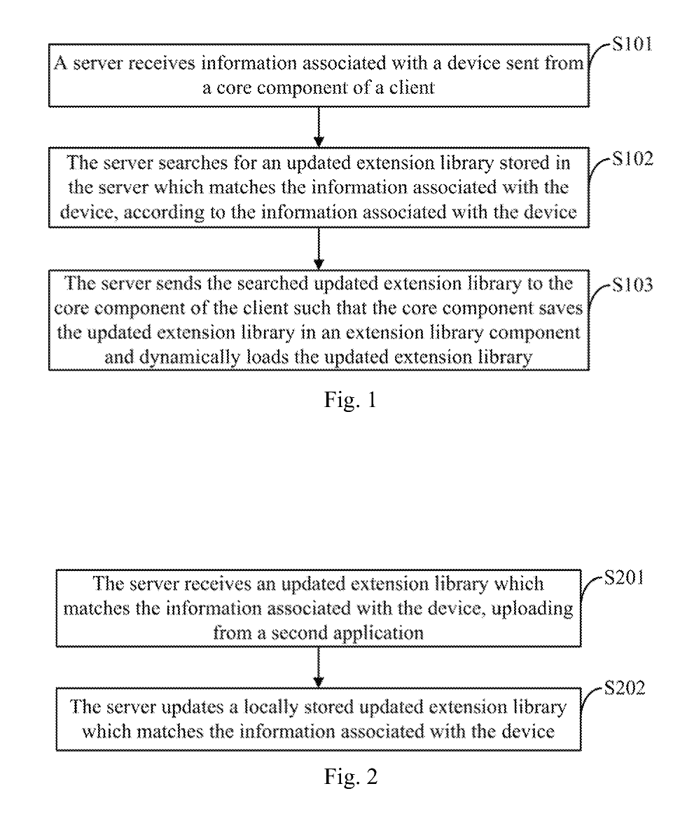

An embodiment of the present disclosure provides a self-updating method for remote assistance which is implemented at a server side, as illustrated in FIG. 1, including the following operations.

S101: a server receives information associated with a device sent from a core component of a client running on the device.

S102: the server searches for an updated extension library stored in the server which matches the information associated with the device.

S103: the server sends the searched updated extension library to the core component of the client such that the core component saves the updated extension library in an extension library component of the client and dynamically loads the updated extension library.

According to an embodiment of the present disclosure, the extension library component of the client is automatically updated without any interaction between the user and the manufacturer of the device through the above operations S101 to S103. Particularly, after receiving the information associated with the device sent by the core component of the client, the server searches for a stored updated extension library that matches the information associated with the device automatically, wherein the updated extension library is the latest extension library provided by an administrator of the manufacturer of the device; after the server sends the searched updated extension library to the core component of the client, the core component saves the updated extension library in the extension library component and dynamically loads the updated extension library, so as to automatically update the client.

Optionally, according to an embodiment of the present disclosure, as illustrated in FIG. 2, the method further includes the following operations.

S201: the server receives an updated extension library which matches the information associated with the device, uploading from a second application.

S202: the server updates a locally stored updated extension library which matches the information associated with the device.

Particularly, according to an embodiment of the present disclosure, the latest updated extension library is saved at the server side through the above operations S201 to S202. Particularly, after the manufacturer of the device updates an extension library, the administrator of the manufacturer of the device uploads the updated extension library of all model numbers to the server via the second application, to ensure that the server stores the latest updated extension library for all model numbers so that the client on a device automatically downloads the updated extension library associated with the model of the device from the server side.

Particularly, the second application is a browser which is used by the CSR to log in an interface, or a client which is running on the CSR's computer, which is not limited herein.

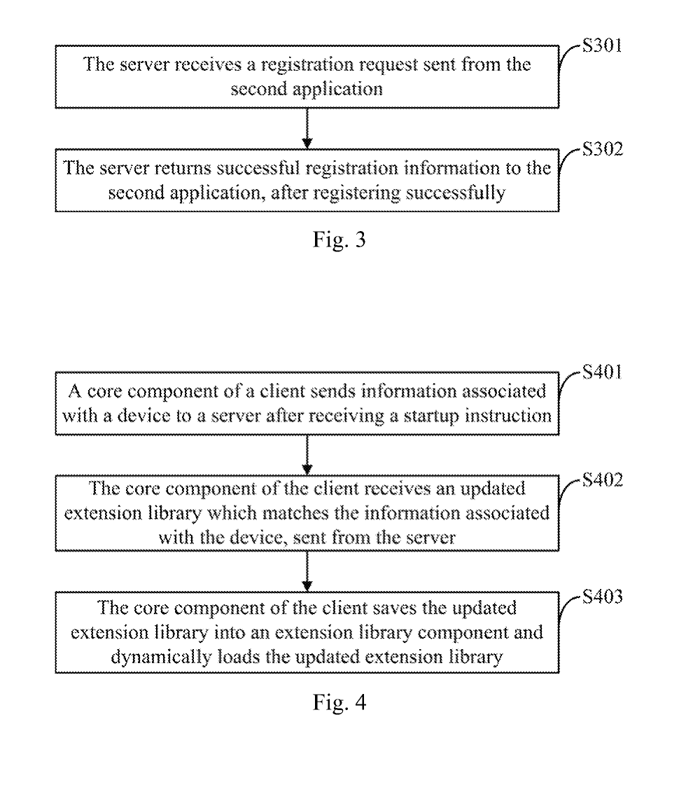

Optionally, according to an embodiment of the present disclosure, as illustrated in FIG. 3, before the operation S201 where the server receives the updated extension library which matches the information associated with the device, uploading from the second application, the method further include following operations.

S301: the server receives a registration request sent from the second application.

S302: the server returns successful registration information to the second application, after registering successfully.

Particularly, according to an embodiment of the present disclosure, a communication channel is established between the second application running on the manufacturer side of the device and the server through the above operations S301 to S302. Particularly, when the administrator of the manufacturer of the device logs in the server for the first time, it needs to register with the server so as to subsequently upload the updated extension library through a registration account.

Optionally, according to an embodiment of the present disclosure, the information associated with the device includes one or more of a model number, a version of current running software on the device, etc. The software version includes the version of the core component, and further includes the software version of the extension component, and the like.

Based on the same inventive concept, an embodiment of the present disclosure provides a self-updating method for remote assistance which is implemented at a client side, as illustrated in FIG. 4, including the following operations.

S401: a core component of a client running on a device sends information associated with the device to a server after receiving a startup instruction.

S402: the core component of the client receives an updated extension library which matches the information associated with the device, sent from the server.

S403: the core component of the client saves the updated extension library into an extension library component of the client and dynamically loads the updated extension library.

Particularly, according to an embodiment of the present disclosure, the extension library component of the client is automatically updated without any interaction between the user and the manufacturer of the device through above operations S401 to S403. Particularly, since the core component of the client automatically sends the information associate with the device (for example, the model number of the product and the current software version and the like) to the server after receiving the startup instruction (for example, from the user), so that the server uses the information associated with the device to search for a stored updated extension library that matches the information, wherein the updated extension library is the latest extension library provided by the administrator of the manufacturer of the device. For example, by using the model number of the device and the like, all available extension libraries corresponding to the device of the model number in an extension library locally stored by the server are inquired, and whether the current version information of the device includes all available extension libraries corresponding to the device of the model number is checked; if the current version information of the device does not include some currently available extension libraries, an available extension library component not included in the current version information is sent to the client. After receiving the updated available extension library, the core component of the client saves the updated available extension library into the extension library component of the client and dynamically loads the updated extension library, so as to automatically update the client, especially the extension library component of the client.

Particularly, the core component of the client serves as a communication conduit between the extension library component of the client and the server, and the core component implements all functionalities which are associated with the communication with the server. And, the core component calls and dynamically loads extension libraries in the extension library component.

Optionally, according to an embodiment of the present disclosure, the information associated with the device includes one or more of a model number, a version of current running software on the device, etc. The software version includes the version of the core component, and further includes the software version of the extension component, and the like.

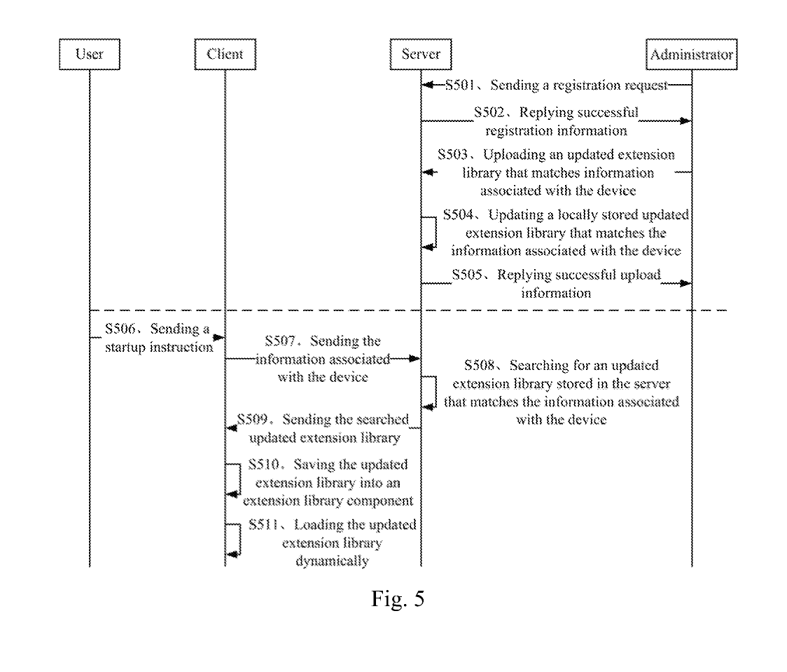

Particularly, the complete interaction process of the self-updating method for remote assistance according to an embodiment of the present disclosure, as illustrated in FIG. 5, includes the following operations.

S501: a second application used by an administrator of a manufacturer of a device sends a registration request to a server.

S502: the server replies successful registration information to the second application.

S503: the second application uploads an updated extension library that matches information associated with the device to the server.

S504: the server updates a locally stored updated extension library that matches the information associated with the device.

S505: the server replies successful upload information to the second application.

S506: a startup instruction from the user is received by a client.

S507: a core component of the client sends the information associated with the device to the server.

S508: the server searches for an updated extension library stored in the server that matches the information associated with the device.

S509: the server sends the searched updated extension library to the core component of the client.

S510: the core component of the client saves the updated extension library into an extension library component of the client.

S511: the core component of the client dynamically loads the updated extension library.

The function of uploading the latest updated extension library between the second application used by the administrator and the server is achieved by operations S501 to S505. The self-updating function between the client and the server is achieved by operations S506 to S511.

According to an embodiment of the present disclosure, automatic update for remote assistance of client software of a smart television is achieved, where the client is installed on the smart television, and the server is a cloud server.

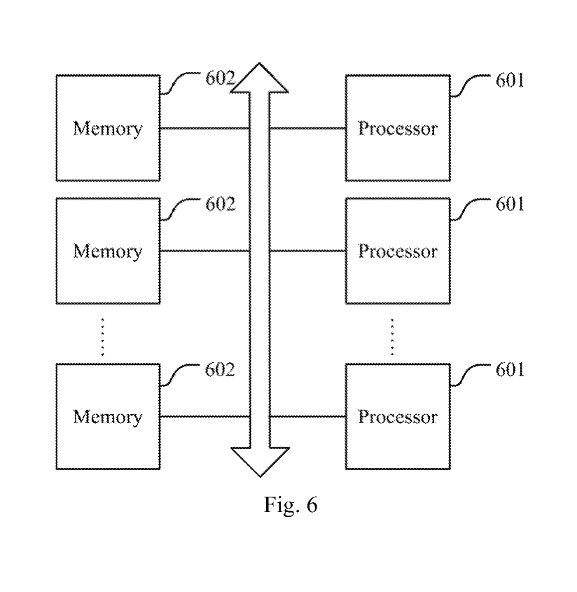

Based on the same inventive concept, an embodiment of the present disclosure further provides a server, as illustrated in FIG. 6, which includes: a processor 601 and a memory 602, wherein the memory 602 stores a computer program and execution of the computer program by the processor 601 causes the processor 601 to: receive information associated with a device sent from a core component of a client which is running on the device; search for an updated extension library stored in the server which matches the information associated with the device; and send the searched updated extension library to the core component of the client such that the core component saves the updated extension library in an extension library component of the client and dynamically loads the updated extension library.

Optionally, according to an embodiment of the present disclosure, the execution of the computer program by the processor 601 further causes the processor 601 to: receive an updated extension library which matches the information associated with the device, uploading from a second application; and update a locally stored updated extension library which matches the information associated with the device.

Optionally, according to an embodiment of the present disclosure, the execution of the computer program by the processor 601 further causes the processor 601 to: receive a registration request sent from the second application before receiving the updated extension library which matches the information associated with the device, uploading from the second application; and return successful registration information to the second application after registering successfully.

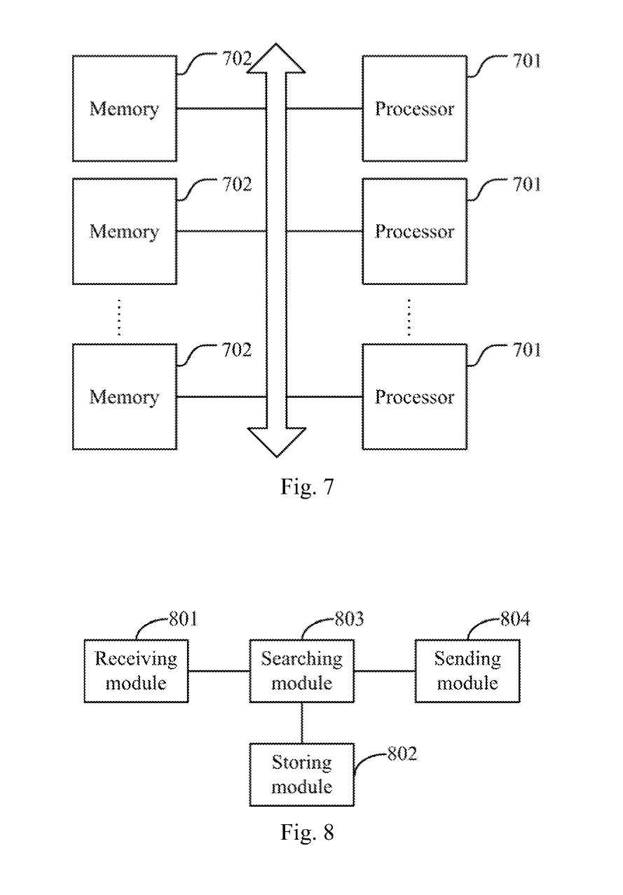

Based on the same inventive concept, an embodiment of the present disclosure further provides a terminal, as illustrated in FIG. 7, which includes: a processor 701 and a memory 702, where the memory 702 stores a computer program and execution of the computer program by the processor 701 causes the processor 701 to: send information associated with the terminal to a server after receiving a startup instruction; receive an updated extension library which matches the information associated with the terminal, sent from the server; and save the updated extension library into an extension library component within the terminal and dynamically load the updated extension library.

Based on the same inventive concept, an embodiment of the present disclosure further provides a server, as illustrated in FIG. 8, including: a receiving module 801, configured to receive information associated with a device sent from a core component of a client which is running on the device; a storing module 802, configured to store an updated extension library which matches the information associated with the device; a searching module 803, configured to search for an updated extension library stored in the server which matches the information associated with the device; and a sending module 804, configured to send the searched updated extension library to the core component of the client such that the core component saves the updated extension library in an extension library component of the client and dynamically loads the updated extension library.

Optionally, according to an embodiment of the present disclosure, the receiving module 801 is further configured to receive an updated extension library which matches the information associated with the device, uploading from a second application; the storing module 802 is configured to update a locally stored updated extension library which matches the information associated with the device.

Optionally, according to an embodiment of the present disclosure, the receiving module 801 is further configured to receive a registration request sent from the second application before receiving the updated extension library which matches the information associated with the device, uploading from the second application; the sending module 804 is further configured to return successful registration information to the second application after registering successfully.

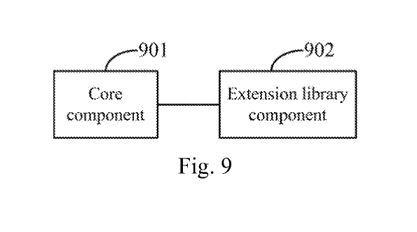

Based on the same inventive concept, an embodiment of the present disclosure further provides a client, as illustrated in FIG. 9, including a core component 901 and an extension library component 902; the core component 901 is configured to send information associated with a device on which the client is running to a server after receiving a startup instruction, to receive an updated extension library which matches the information associated with the device, sent from the server; and to load the updated extension library dynamically; the extension library component 902 is configured to save the updated extension library.

Optionally, various aspects of a self-updating method for remote assistance according to an embodiment of the present disclosure may be implemented in the form of a program product, which includes program codes; the program codes are configured to enable computing equipment to execute operations of a self-updating method for remote assistance according to an exemplary embodiment of the present disclosure when the program codes run on the computing equipment.

The program product may be implemented with any combination of one or more readable mediums. A readable medium may be a readable signal medium or a readable storage medium. A readable storage medium may be, for example, but not limited to, an electrical, magnetic, optical, electromagnetic, infrared, or semiconductor system, apparatus, or device, or any combination thereof. A more particular example of a readable storage medium (non-exhaustive list) includes: an electrical connection having one or more wires, a portable disk, a hard disk, a random access memory (RAM), a read only memory (ROM), an erasable programmable read-only memory (EPROM or flash memory), optical fiber, a portable compact disk read-only memory (CD-ROM), an optical storage device, a magnetic storage device, or any suitable combination thereof.

The program product according to an embodiment of the present disclosure may be implemented with a portable compact disk read-only memory (CD-ROM) and include program codes and may be run on a server device. However, the program product of the present disclosure is not limited thereto, and a readable storage medium herein may be any tangible medium that contains or stores a program that can be used by or in connection with an information transmission apparatus or device.

The readable signal medium may include data signals propagating in the baseband or as part of a carrier and carries readable program codes therein. The data signals propagating in this way may take many forms, including but not limited to electromagnetic signals, optical signals, or any suitable combination of the foregoing. The readable signal medium may also be any readable medium other than a readable storage medium, and the readable medium may send, propagate, or transmit programs for use by or in connection with a periodic network action system, apparatus, or device.

The program codes included in the readable medium may be transmitted by using any appropriate medium, including but not limited to wireless, wired, optical fiber cable, RF, etc., or any suitable combination of the foregoing.

The program codes for carrying out operations of the present disclosure may be written in any combination of one or more programming languages, including object-oriented programming languages such as Java, C++ and the like, as well as conventional procedural programming design languages, such as “C” language or similar programming languages. The program codes may be executed entirely on a user computing device, executed partly on the user equipment, executed as a stand-alone software package, executed partly on the user computing device and partly on a remote computing device or entirely executed on the remote computing device or a server. In the context of a remote computing device, the remote computing device may be connected to a user computing device through any type of network, including a local area network (LAN) or a wide area network (WAN) or may be connected to an external computing device.

The self-updating method for remote assistance according to an embodiment of the present disclosure further provides a machine readable non-transitory storage medium, that is, the content is not lost after the power is turned off. The storage medium stores a software program, including program codes. When the program codes run on computing equipment, the software program may be read and executed by one or more processors to implement a solution for debugging any of the above devices in the embodiments of the present disclosure.

The self-updating method for remote assistance according to an embodiment of the present disclosure further provides a machine readable non-transitory storage medium, that is, the content is not lost after the power is turned off. The storage medium stores a software program, including program codes. When the program codes run on computing equipment, the software program may be read and executed by one or more processors to implement a solution of any of the self-updating methods for remote assistance according to the embodiments of the present disclosure.

According to an embodiment of the present disclosure, after receiving a startup instruction, a core component of a client running on a device automatically sends information associated with the device to a server, and by using the information associated with the device, the server searches for a stored updated extension library that matches the information associated with the device, wherein the updated extension library is the latest extension library provided by an administrator of a manufacturer of the device. After the server sends the searched updated extension library to the core component of the client, the core component saves the updated extension library in an extension library component of the client and dynamically loads the updated extension library, so as to automatically update the client.

The disclosure has been described in a block diagram and/or a flow chart of the method, the device (system) and/or the computer program product according to the embodiments of the disclosure. It shall be appreciated that respective blocks and/or flows in the block diagram and/or the flow chart and combinations of the blocks and/or the flows in the block diagram and/or the flow chart can be embodied in computer program instructions. These computer program instructions can be loaded onto a processor of a general-purpose computer, a specific-purpose computer, and/or other programmable data processing apparatuses to produce a machine so that the instructions executed on the computer processor and/or other programmable data processing apparatuses create means for performing the functions specified in the block(s) of the block diagram and/or the flow(s) of the flow chart.

Accordingly, this application may also be implemented in hardware and/or software (including firmware, resident software, microcode, etc.). Further, this application may take the form of a computer program product on a computer-usable or computer-readable storage medium, and the product includes computer-usable or computer-readable program codes implemented in a medium so as to be used by an instruction execution system or used in conjunction with an instruction execution system. In the context of the present application, a computer-usable or computer-readable medium may be any medium that can contain, store, communicate, transfer, or transmit the program for use by an instruction execution system, apparatus, or device, or used in conjunction with an instruction execution system, apparatus or device.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A self-updating method for remote assistance, the method comprising:
receiving, by a server, information associated with a device sent from a core component of a client which is an application configured to run on the device, wherein the client comprises the core component and an extension library component including extension libraries, wherein the core component is configured to serve as a communication conduit between the extension library component and the server and to implement all functionalities associated with communication with the server, and wherein the extension libraries in the extension library component are libraries called and dynamically loaded by the core component;
searching, by the server, for an updated extension library stored in the server which matches the information associated with the device; and
sending, by the server, the searched updated extension library to the core component of the client such that the core component saves the updated extension library in an extension library component of the client and dynamically loads the updated extension library.

2. The method according to claim 1, further comprising:
receiving, by the server, an updated extension library which matches the information associated with the device, uploading from a second application; and
updating, by the server, a locally stored updated extension library which matches the information associated with the device.

3. The method according to claim 2, wherein, before receiving, by the server, the updated extension library which matches the information associated with the device, uploading from a second application, the method further comprising:
receiving, by the server, a registration request sent from the second application; and
returning, by the server, successful registration information to the second application, after registering successfully.

4. The method according to claim 1, wherein the information associated with the device comprises one or more of a model number and a software version of current running software of the device.

5. A self-updating method for remote assistance, the method comprising:
sending, by a core component of a client which is an application configured to run on a device, information associated with the device to a server after receiving a startup instruction, wherein the client comprises the core component and an extension library component including extension libraries, wherein the core component is configured to serve as a communication conduit between the extension library component and the server and to implement all functionalities associated with communication with the server, and wherein the extension libraries in the extension library component are libraries called and dynamically loaded by the core component;
receiving, by the core component of the client, an updated extension library which matches the information associated with the device, sent from the server; and
saving, by the core component of the client, the updated extension library into an extension library component of the client and dynamically loading the updated extension library.

6. The method according to claim 5, wherein the information associated with the device comprises one or more of a model number and a software version of current running software of the device.

7. A server, comprising a memory and a processor, wherein the memory is configured to store a computer program and wherein execution of the computer program by the processor is configured to cause the processor to:
receive information associated with a device sent from a core component of a client which is an application configured to run on the device, wherein the client comprises the core component and an extension library component including extension libraries, wherein the core component is configured to serve as a communication conduit between the extension library component and the server and to implement all functionalities associated with communication with the server, and wherein the extension libraries in the extension library component are libraries called and dynamically loaded by the core component;
search for an updated extension library stored in the server which matches the information associated with the device; and
send the searched updated extension library to the core component of the client such that the core component saves the updated extension library in an extension library component of the client and dynamically loads the updated extension library.

8. The server according to claim 7, wherein execution of the computer program by the processor is further configured to cause the processor to:
receive an updated extension library which matches the information associated with the device, uploading from a second application; and
update a locally stored updated extension library which matches the information associated with the device.

9. The server according to claim 8, wherein execution of the computer program by the processor is further configured to cause the processor to:
receive a registration request sent from the second application before receiving the updated extension library which matches the information associated with the device, uploading from the second application; and
return successful registration information to the second application after registering successfully.

10-12. (canceled)
